(19) United States
(12) Patent Application Publication
(10) Pub. No.: US 2006/0238049 A1
(43) Pub. Date: Oct. 26, 2006

(54) Method for mounting an electric motor

(76) Inventors: Markus Heinzel, Donzdorf (DE); Jurgen Lang, Backnang (DE); Michael Leonhardt, Stuttgart (DE)

Correspondence Address: KLAUS J. BACH, 4407 TWIN OAKS DRIVE, MURRYSVILLE, PA, 15668, US

(21) Appl. No.: 11/437,256

(22) Filed: May 19, 2006

Related U.S. Application Data
(63) Continuation-in-part of application No. PCT/EP04/12405, filed on Nov. 3, 2004.

(30) Foreign Application Priority Data
Nov. 21, 2003 (DE) 103 54 766.5

(51) Int. Cl. H02K 5/00

(52) U.S. Cl. 310/89

(57) ABSTRACT

In an electric motor having a housing and a rotor for installation in a drive train, the housing includes centering elements which retain the rotor centered in the housing for facilitating mounting of the motor to the drive train, the centering elements being movable out of their centering position during assembly and being retained out of contact with the rotor as long as the motor is installed but being released to assume their centering position whenever the motor is removed from the drive train.

This is a Continuation-In-Part Application of International Application PCT/EP2004/012405 filed Nov. 3, 2004 and claiming the priority of German application 103 54 766.5 filed Nov. 21, 2003.

### BACKGROUND OF THE INVENTION

The invention relates to an electric motor comprising a stator and a rotor and to a drive of a motor vehicle comprising an electric motor.

Patent specification GB 1 572 619 A (corresponding to DE 26 47 031 A1), which forms this generic type, discloses centering a rotor in a stator, when mounting an electric motor, wherein the rotor with associated bearings and bearing supports is pushed in the axial direction into an opening in the stator until annular centering areas which are arranged on the rotor or stator interact with a corresponding area of the stator or rotor, which area is concentric but offset in the axial direction. The bearing supports are connected to the stator in this position, and the rotor is then pushed back in the other axial direction together with the bearings until the annular centering area which is arranged on the stator or rotor is released from the corresponding concentric area of the rotor or stator.

One disadvantage of this is that centering the rotor in the stator involves several working steps, and this increases the cost of mounting the electric motor and the amount of time required for mounting.

It is the object of the present invention to simplify mounting of an electric motor which comprises a stator and a rotor, and also to simplify a drive train which comprises such an electric motor.

### SUMMARY OF THE INVENTION

In an electric motor having a housing and a rotor for installation in a drive train, the housing includes centering elements which retain the rotor centered in the housing for facilitating mounting of the motor to the drive train, the centering elements being movable out of their centering position during assembly and being retained out of contact with the rotor as long as the motor is installed but being released to assume their centering position whenever the motor is removed from the drive train.

The electric motor which comprises a stator and a rotor is installed particularly between an internal combustion engine and a drive train of a motor vehicle.

The centering elements are integrated in the stator or in the stator housing and remain there after the rotor is mounted. Involved insertion and removal of separate centering aids are therefore not necessary, and this significantly simplifies mounting of the electric motor. Design measures for the housing of the electric motor, for example openings which weaken the structure of the housing and through which dirt and moisture can enter the electric motor—in particular when used in a motor vehicle—can also be dispensed with. The centering elements, which are integrated in the housing, furthermore ensure that the rotor is centered in the stator during subsequent mounting following a preceding demounting operation.

It is also advantageous for the centering elements to rest on the rotor in a centering position and be arranged at a distance from the rotor in an operating position.

On account of this arrangement, bearing forces, which act radially to the main axis of the electric motor in particular, lead to centering and/or to the transportation position in the centering position, with the rotor being arranged and secured in the center of the stator or the stator housing. These bearing forces do not have any effect in the operating position since the centering elements are at a distance from the rotor in this case.

With the arrangement according to the centering elements are moved from the centering position to the operating position during the installation of the stator or the stator housing.

The movement of the centering elements from the centering position to the operating position advantageously is in the axial direction; in the process, the centering elements are shifted along an axis which extends parallel to the main axis of the electric motor.

One advantageous refinement of the invention proposes that the movement of the centering elements from the centering position to the operating position can be provided by fitting the electric motor with an adjacent component. The movement from the centering position to the operating position may advantageously be linked to the distance from the adjacent component, so that the centering elements are moved from the centering position to the operating position by the electric motor and the adjacent component approaching each other, for example. Accordingly, in the case of this very elegant solution, a user does not need to take any special action in order to move the centering elements from the centering position to the operating position.

Further preferred refinements of the invention propose that the centering elements are centering pins or bolts, and that they are advantageously supported elastically or by means of energy storage devices. In contrast to the special centering aids known from the prior art, commercially available centering pins or bolts do not significantly increase production costs and, from a cost point of view, can therefore also remain in the electric motor housing after the rotor is mounted. On account of said centering elements being supported elastically or by means of energy storage devices, they are functional again without problems, for example during servicing, even in the demounted state, when it is not absolutely necessary to center the rotor in the stator, and during subsequent remounting of the electric motor.

One further development of the invention provides for the centering elements to be arranged parallel to a main axis of the rotor and mounted in passages in the stator housing. This ensures that the centering pins or bolts which are proposed as centering elements are recessed in the openings in the stator housing or in the housing of the electric motor when the stator and rotor are assembled, without additional efforts and without the need for auxiliary means. The same applies during disassembly and subsequent re-assembly.

The invention will become more readily apparent from the following description of preferred embodiments thereof on the basis of the accompanying drawings.

### BRIEF DESCRIPTION OF THE DRAWINGS

FIG. 1 is an exploded view of a drive train of a motor vehicle comprising an electric motor,

FIGS. 2a-c are detailed illustrations of a first refinement of a centering aid which is integrated in the stator housing of the electric motor before, during and after mounting of the rotor,

FIG. 3 is a detailed illustration of a second refinement of a centering aid which is integrated in the stator housing of the electric motor,

FIG. 4a is a detailed illustration of a third refinement of a centering aid which is integrated in the stator housing of the electric motor, and

FIG. 4b is a sectional illustration of the third refinement of a centering aid according to FIG. 4a.

### DESCRIPTION OF A PARTICULAR EMBODIMENT

The invention is suitable particularly for the assembly of an electric motor comprising a rotor and a stator.

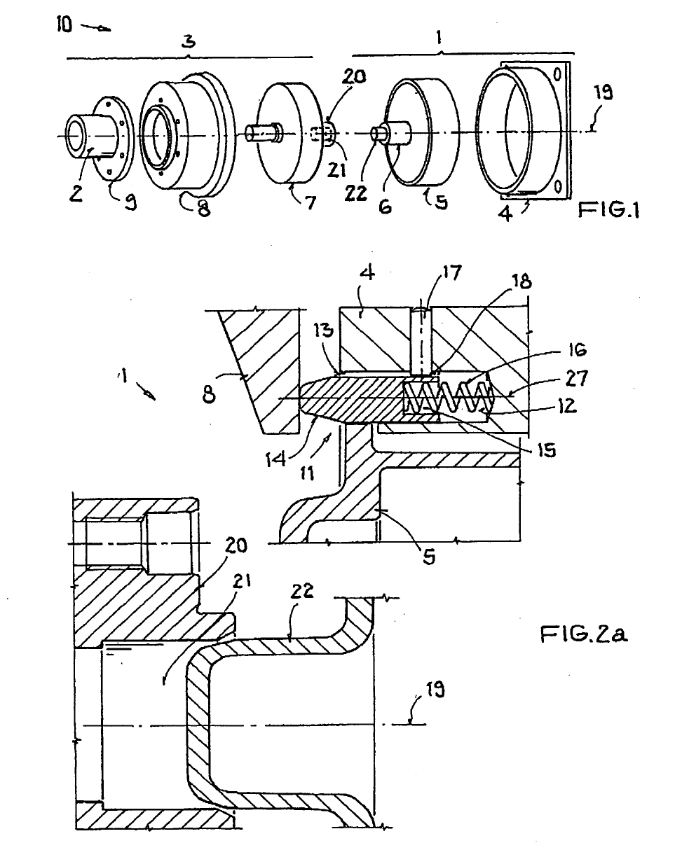

FIG. 1 shows a section of a drive train 10 comprising an electric motor 1 and a gear mechanism 3, for example an automatic power transmission. The electric motor 1 comprises a stator or a stator housing 4 and a rotor 5, and the transmission 3 comprises, for example, a start-up element 7 with an associated housing 8. Examples of possible start-up elements 7 are a hydrodynamic torque converter and a dry or wet start-up clutch. The electric motor 1 is, for example, a permanently excited synchronous motor with permanent magnets for field generation. FIG. 1 also shows a shaft 2 with a flange 9. The shaft 2 is, for example, a crankshaft of a drive motor, a gear mechanism input shaft, a cardan shaft, a rear-axle gear mechanism shaft, a lateral shaft or any other drive shaft. The flange 9 is attached to the housing 8 by means of screws or bolts, for example.

The rotor 5 has a drive/output shaft 6, with the free end of the drive/output shaft 6 having a centering pin 22. The start-up element 7 has an output shaft 20.

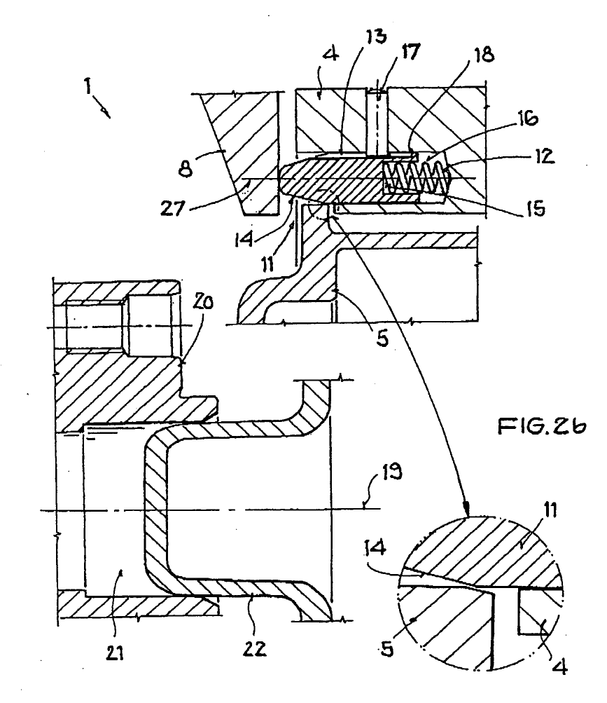

In the state as supplied for assembly, the electric motor 1 is already mounted, that is to say the rotor 5 is fitted concentrically into the stator 4 and is held in this state by the centering elements 11 which serve as securing means for transportation. As shown in FIG. 2a, the centering elements 11 are located in a centering position.

During mounting of the illustrated section of the drive train 10, the electric motor 1 and the gear mechanism 3, as well as other parts, have to be connected to one another. To this end, firstly the stationary stator housing 4 and the stationary housing 8 have to be connected to one another, for example by means of screwing arrangements, and secondly the rotating shaft 6 and the rotating shaft 20 have to be joined, for example by being nested. After the two shafts 6 and 20 are joined, the securing means for transportation which are in the form of the centering elements have to be moved from their centering position to an operating position, so that the rotor 5 can rotate freely in the stator 4.

In the completely mounted state, firstly the now rotatable rotor 5 is connected to the shaft 20 of the start-up element 7 by its drive/output shaft 6 and secondly the stator or the stator housing 4 is connected to the housing 8 of the start-up element 7.

FIG. 2c shows the arrangement after the housing 8 and the stator 4 are assembled. Each centering element 11 is now located in the operating position and is pushed so far into the associated hole 12 that its tip 14 no longer touches the rotor 5 but instead is arranged at a distance from the rotor 5. In this mounting stage, the centering pin 22 is inserted so far into the centering hole 21 that the position of the rotor 5 is fixed in the radial direction and it is no longer necessary to center said rotor in the stator 4 by means of the centering elements 11. After mounting is complete, the centering elements 11 remain recessed in the respectively associated hole 12 in the operating position.

The centering elements 11 are prevented from falling out of the respective holes 12 by a retaining pin 17, which extends through the housing 4 into an axial groove 13 formed into each centering element 11 and provided at its inner end with a stop 18 which abuts the pin 17 when the centering element 11 reaches its fully extended position under the force of the spring 16 disposed between the housing 4 and the respective support wall 15 of the centering element 11.

During removal of stator 4 from the housing 8, the centering elements 11 move out of the passage or hole 12 again and into the centering position on account of being mounted elastically for example by compression springs 16 for positioning the rotor 5 in relation to the stator 4. They therefore prevent the rotor 5 from bearing on the stator 4 on account of the magnetic forces when the centering pins 22 are withdrawn from the centering hole 21 which performs positioning. The centering elements 11 can be used for further demounting and mounting operations as often as desired.

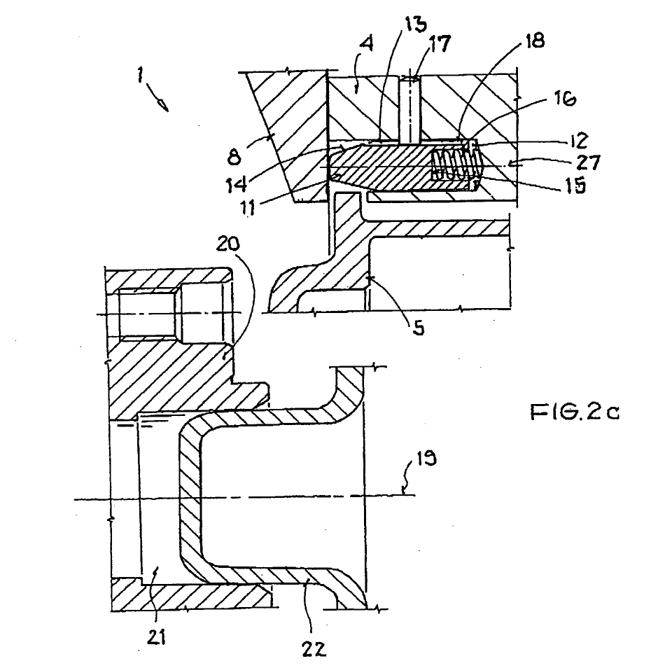

FIG. 3 shows a second embodiment of centering elements 11′ which are integrated in the stator housing 4 of the electric motor 1. The centering elements 11′ have a first cross-section region 23 and a second cross-section region 24 which is tapered in relation to the first cross-section region 23. The rotor 5, in the region of the first cross-section region 23, rests on the centering elements 11′ in the centering position (not illustrated here); the first cross-section regions 23 are at a distance from the rotor 5 in the operating position shown here. The second cross-section regions 24 are located in the region of the rotor 5 in the operating position, with the second cross-section region 24 not resting on the rotor 5 on account of their reduced cross sections.

The transition from the first cross-section region 23 to the second cross-section region 24 may be smooth, stepped or have another profile. As in the exemplary embodiment of FIGS. 2a-c, the changeover from the centering position to the operating position is made by a translatory movement of the centering elements 11′, with this movement of the centering elements 11′ being caused by the electric motor 1 and the housing 8 as the adjacent component being brought together.

The centering elements 11′ are secured against falling out of the hole 12 by similar measures to those in the exemplary embodiment from FIGS. 2a-c, for example. The shape, contour and dimensions of the centering elements 11′, in particular their cross-section regions 23 and 24, on the one hand and those of the centering hole 21 (FIGS. 1, 2a-c) and of the centering pin 22 (FIGS. 1, 2a-c), on the other in turn have to be matched to one another.

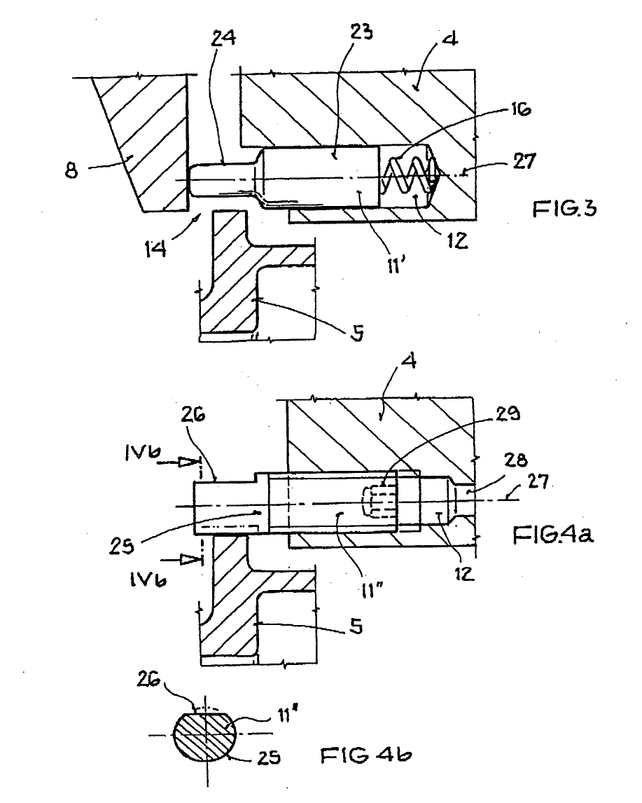

FIGS. 4a, b show a further exemplary embodiment of centering elements 11″. In this case, the centering elements 11″ have different cross-section regions, to be precise a first cross-section region with a first outer contour 25 and a second cross-section region with a second outer contour 26, with the distance of the second outer contour 26 from the center axis 27 of the centering elements 11″ being smaller than the distance of the first outer contour 25. The transition from the first outer contour 25 to the second outer contour 26 may be smooth, stepped or have another profile.

The rotor 5, in the region of the first outer contour 25, rests on the centering elements 11″ in the centering position; the rotor 5, in the region of the second outer contour 26, is arranged at a distance from the centering elements 11″ in the operating position. A changeover from the centering position to the operating position is made by a rotary movement of the centering elements 11″ about the center axis 27.

In this case, the movement of the centering elements 11″ may be applied manually by, for example, a suitable tool such as a wrench or Allen key (hexagonal wrench) being inserted through a hole 28 which passes through the stator housing 4, placed into a receiving structure 29 which matches the tool, and being manually or automatically turned or rotated about the center axis 27.

The centering elements 11″ are secured against falling out of the hole 12 by similar measures to those in the exemplary embodiment from FIGS. 2a-c, for example. The shape, contour and dimensions of the centering elements 11″, in particular their contours 25 and 26, on the one hand and those of the centering hole 21 (FIGS. 1, 2a-c) and of the centering pin 22 (FIGS. 1, 2a-c), neither of which is illustrated here, on the other in turn have to be matched to one another.

What is claimed is:

1. An electric motor comprising a stator housing (4) and a rotor (5), and centering elements (11; 11′; 11″) for centering the rotor (5) in the stator housing (4),
the centering elements (11; 11′; 11″) being integrated in the stator or in the stator housing (4) and remaining in the stator housing (4) after assembly of the motor in a drive train is completed,
said the centering elements (11; 11′; 11″) retaining the rotor (5) in a centered position but being displaced upon assembly so as to be arranged at a distance from the rotor (5) in an operating position of the motor,
said centering elements (11; 11′; 11″) being movable from the rotor centering position to the operating position by being moved in relation to the stator housing (4).

2. The electric motor as claimed in claim 1, wherein the centering elements (11; 11′) are arranged so that they are moved out of their centering position upon fitting the electric motor (1) with an adjacent component (8).

3. The electric motor as claimed in claim 1, wherein the centering elements (11′) have a first cross-section region (23) and a second cross-section region (24) which is tapered in relation to the first cross-section region (23),
the rotor (5), in the region of the first cross-section regions (23), resting on the centering elements (11′) in the centering position, and
the centering elements (11′) being movably in a translatory manner in order to change over from the centering position to the operating position, in which the rotor (5), is disposed adjacent the second cross-section regions (24), in spaced relation with respect to the centering elements (11′).

4. The electric motor as claimed in claim 1, wherein
the centering elements (11″) have a cross section with a first outer contour (25) and a second outer contour (26) whose distance from a center axis (27) of the centering elements (11″) is smaller than the distance of the first outer contour (25),
the rotor (5) in the region of the first outer contour (25), resting on the centering elements (11″) in the centering position, and
the centering elements (11″) being rotatable in order to change over from the centering position to the operating position, in which
the rotor (5) is arranged at a distance from the centering elements (11″).

5. The electric motor as claimed in claim 1, wherein the centering elements (11; 11′; 11″) are mounted in a hole (12) in the stator housing (4).

6. The electric motor as claimed in claim 5, wherein the centering elements (11; 11′; 11″) are elastically supported in the hole (12) in the longitudinal direction.

7. The electric motor as claimed in claim 6, wherein the centering elements (11; 11′; 11″) are supported in the hole (12) in the longitudinal direction by means of energy storage devices (16).

8. The electric motor as claimed in claim 5, wherein the centering elements (11; 11′; 11″) extend parallel to a main axis (19) of the electric motor (1).

9. The electric motor as claimed in claim 5, wherein securing elements (17, 18) are provided for retaining the centering elements (11; 11′; 11″) in the hole (12).

10. An electric motor comprising a stator housing (4) and a rotor (5), and centering elements (11; 11′; 11″) for centering the rotor (5) in the stator housing (4),
the centering elements (11; 11′; 11″) being integrated in the stator or in the stator housing (4) and remaining in the stator housing (4) after assembly of the motor in a drive train is completed,
said the centering elements (11; 11′; 11″) retaining the rotor (5) in a centered position but being displaced upon assembly so as to be arranged at a distance from the rotor (5) in an operating position of the motor,
said centering elements (11; 11′; 11″) being movable from the rotor centering position to the operating position by being moved in relation to the stator housing (4), said electric motor (1) being included in the drive train as a starter/generator.

11. The drive train of a motor vehicle, as claimed in claim 10, wherein the electric motor (1) is part of a hybrid drive.
